(19) United States
(12) Patent Application Publication
(10) Pub. No.: US 2019/0035295 A1
(43) Pub. Date: Jan. 31, 2019

(54) METHOD AND APPARATUS FOR PROVIDING A GUIDE TO DEVELOPMENT

(71) Applicant: AARP, Washington, DC (US)

(72) Inventor: Emilio PARDO, Silver Spring, MD (US)

(73) Assignee: AARP, Washington, DC (US)

(21) Appl. No.: 15/755,899

(22) PCT Filed: Aug. 31, 2016
(86) PCT No.: PCT/US16/49752

§ 371 Date: Feb. 27, 2018

Related U.S. Application Data
(60) Provisional application No. 62/212,277, filed on Aug. 31, 2015.

(51) Int. Cl. G09B 7/00

(52) U.S. Cl. CPC G09B 7/00

(57) ABSTRACT

The disclosure provides a personal development system for encouraging personal discovery and fulfillment of goals. The personal development system includes an interactive computer system for presenting a series of interfaces that probe a user to evaluate his or her gifts, passions, impacts, and values. The system also provides interfaces for determining what the user would like to be, feel, or have. The system uses the collected information to provide the user with insight into his or her purpose. The system may present a first set of cards, each card in the first set representing a personal trait, receive a first selected subset of at least a minimum number of the first set of cards, present the selected subset of cards, receive a second selected subset of a maximum number from the first selected subset, present the second selected subset, and receive a selected order for the second selected subset.

### CLAIM OF PRIORITY UNDER 35 U.S.C. § 119

The present application for patent is a National Stage Entry of International Patent Application No. PCT/US2016/049752, filed on Aug. 31, 2016, which claims priority to Provisional Application No. 62/212,277 entitled “METHOD AND APPARATUS FOR PROVIDING A GUIDE TO DEVELOPMENT” filed Aug. 31, 2015, the entirety of each of which is hereby expressly incorporated by reference herein.

### BACKGROUND

Individuals are often unsure of a purpose for their lives. People often experience unexpected events. They also experience changes in abilities and opinions. These changes often leave individuals without a sense of purpose or other difficulties in planning for life. An individual may understand that she needs to make a transition, but may not know what she wants out of life.

People seek guidance from a variety of sources such as family, friends, professionals, books, and social groups. While such guidance may be helpful, it may not provide a structured system for helping an individual make personal discoveries or systematically plan for the future.

Thus, there remains an unmet need in the art to aid individuals in discovering and implementing a purpose.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the disclosure provide a personal development system for encouraging personal discovery, discovery of possibilities, and fulfillment of goals. The personal development system includes an interactive computer system for presenting a series of interfaces that probe a user to evaluate his or her gifts, passions, impacts, and values. The system also provides interfaces for determining what the user would like to be, feel, or have. The system uses the collected information to provide the user with insight into his or her personal purpose statement. In an aspect, the system presents a user with a series of options to be used to prioritize and organize things that are important in the user's life.

The system may present a first set of cards, each card in the first set representing a personal trait, receive a first selected subset of at least a minimum number of the first set of cards, present the selected subset of cards, receive a second selected subset of a maximum number from the first selected subset, present the second selected subset, and receive a selected order for the second selected subset. Accordingly, the user may view an interface presenting a card sorting approach to selecting personal traits.

The system may also generate a personal purpose statement for the user including the traits associated with the second selected subset in the selected order. The system may also generate a map showing each of the traits associated with the second selected subset. The system may present the personal statement and/or the map to the user.

In an aspect, the traits are grouped into categories of personal traits, the categories including at least one of: gifts, passions, impacts, values, or feelings. The system may provide interfaces for repeating the card sorting approach for each of the categories of personal traits. For example, the system may further receive a second selected subset and an order for the second selected subset for each category of personal traits.

In another aspect, the system may provide an action plan including goals and steps for the user. The system may generate and suggest a goal based on a selected personal trait. The system may receive, from the user device via the network, a first step toward achieving the goal. The system or the user may generate a time commitment for achieving the first step. Further, the system may receive, from the user device via the network, an obstacle and generate a second step for overcoming the obstacle.

In an aspect, the system may initiate a video coaching session between a user and a coach via the network, the coach having an expertise related to the goal. The system may determine a balance of coaching time of the user, determine a duration of the video coaching session, and deduct the duration of the video coaching session from the balance of coaching time.

In an aspect, the system may also generate a user profile including the selected personal traits and select content to provide to the user based on the selected personal traits.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example computer network for connecting a user to a personal development solution.

FIG. 2 is a diagram illustrating an example computer system.

FIG. 3 is a diagram illustrating an example user interface for managing activities.

FIG. 4 is a diagram illustrating an example interface for identifying personal traits.

FIG. 5 is a diagram illustrating user interaction with the interface illustrated in FIG. 4.

FIGS. 6A and 6B illustrate an example interface for narrowing a subset of selected personal traits.

FIGS. 7A and 7B illustrate an example interface for ordering selected traits.

FIG. 8 illustrates an example interface for selecting possibilities.

FIG. 9 illustrates an example interface for displaying a personal purpose statement.

FIG. 10 illustrates an example interface for displaying a personal canvas.

FIG. 11 illustrates an example interface for managing a plan including goals.

FIG. 12 illustrates an example interface for editing a goal.

FIG. 13 illustrates an example interface for managing a goal.

FIG. 14 illustrates a flowchart showing an example method for discovering a personal purpose statement of a user.

FIG. 15 illustrates a flowchart showing an example method of planning to accomplish goals.

FIG. 16 illustrates diagram schematically showing a system architecture for providing a content system.

FIG. 17 illustrates an example interface for displaying user mind states.

FIG. 18 illustrates an example interface for allowing a user to describe their life situation.

FIG. 19 illustrates an example navigation interface.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The disclosure provides a personal development solution for encouraging personal discovery and fulfillment of goals. In an aspect, the personal development solution includes an interactive computer application system for presenting a series of user interfaces that probe a user to evaluate his or her own gifts, passions, impacts, and values. The system also provides interfaces for determining what the user would like to be, feel, or have. The system uses the collected information to provide the user with insight into his or her purpose.

The disclosure also provides a system for the user to identify and accomplish goals based on the discovered purpose. For example, the system may suggest goals based on what the user would like to be, feel, or have.

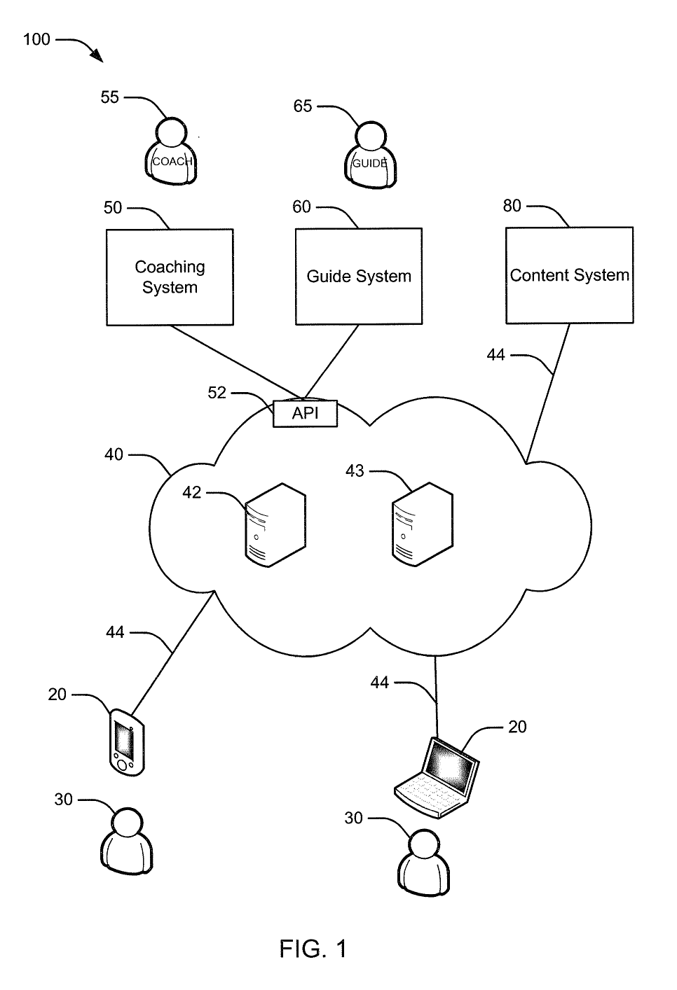

FIG. 1 illustrates an example system 10 including a user device 20. The system 100 may provide a personal development solution for encouraging personal discovery and fulfillment of goals. The user device 20 may provide an interface for a user 30 to interact with the system 100.

The user device 20 may be communicatively coupled to a network 40. The network 40 may include any network that allows communication between the various entities of the system 100. In an aspect, the network 40 may be a communications network and may include or be connected with other networks. For example, the user device 20 may include a modem and be coupled to the network 40 via a wired or wireless connection. The network 40 may include one or more computer servers 42. The computer servers 42 may include information for managing the system 100 including software for providing an interactive online application and personal information for the users 30. In an aspect, for example, the computer servers 42 may include application servers for interacting with user devices 20 for providing various interfaces or notification servers for providing messages to the user 30. The computer servers 42 may also include one or more web servers running web applications that may allow coaches 55, guides 65, or administrators to interact with the system 10 in defined roles. For example, a coaching system 50 may provide an application for coaches 55 to interact the system 100 for providing a coaching service to users 30. As another example, the guide system 60 may provide an application for guides 65 to interact with the system 100 for communicating with users 30. The system 100 may also include systems such as a content system 80 that provides activities or other programming. The network 40 may also include storage servers 43 for storing user information, billing information, etc.

In one aspect of the disclosure, various data is, for example, input and/or accessed by the users 30, coaches 55, guides 65, or other users via terminals such as personal computers (PCs), minicomputers, mainframe computers, microcomputers, telephonic devices, or wireless devices, personal digital assistants (“PDAs”) or a handheld wireless devices (e.g., wireless telephones). The terminals may be coupled to a computer server 42, such as a PC, minicomputer, mainframe computer, microcomputer, or other device having a processor and a repository for data and/or connection to a repository for data, via, for example, the network 40, such as the Internet or an intranet, and/or a wireless network. The couplings 44 include, for example, wired, wireless, or fiber optic links.

A coaching system 50 may schedule and account for live coaching sessions between a user 30 and a coach 55. The system 100 or component thereof (e.g., a server 42) may use information including personal traits of the user 30 to match the user 30 with one or more coaches 55. The coaching system 50 may allow the user 30 to select a coach to assist the user 30 in reaching goals. In an aspect, the coaching system 50 may be coupled to the network 40 via an application programming interface (API) 52. The API 52 may allow the user 30 to share personal information such as personal traits, goals, and obstacles with the selected coach 55 without making such information available to other coaches or users. The API 52 may also restrict the personal information accessible to both the coach 55 and the user 30. For example, the API 52 may not share personal contact information such that the API 52 and coaching system 50 remains the primary contact point between the coach 55 and the user 30. For example, the coaching system 50 may initiate live text chat, screen sharing, and audio or video coaching sessions based on information shared through the API 52.

The guide system 60 may provide for communications between the user 30 and a guide 65. The guide 65 may provide the user 30 with help using the system 100 or any of the interfaces described below. The guide 65 may also direct the user 30 to various features of the system 100. The communications may include, for example, text chat, voice, or video calls, or screen sharing. The guide system 60 may also be coupled to the network 40 via the API 52. The API 52 may implement different rules for access for the coaching system 50 than for the guide system 60. For example, the API 52 may be more restrictive regarding personal information shared with a guide 65.

The content system 80 may provide information or activities to a user 30. In an aspect, the content system 80 may make recommendations of content to a user 30 based on personal information of the user 30. For example, the recommended content may be selected to help users progress toward meeting their goals. In an aspect, the content system 80 may be implemented by one or more of the servers 42.

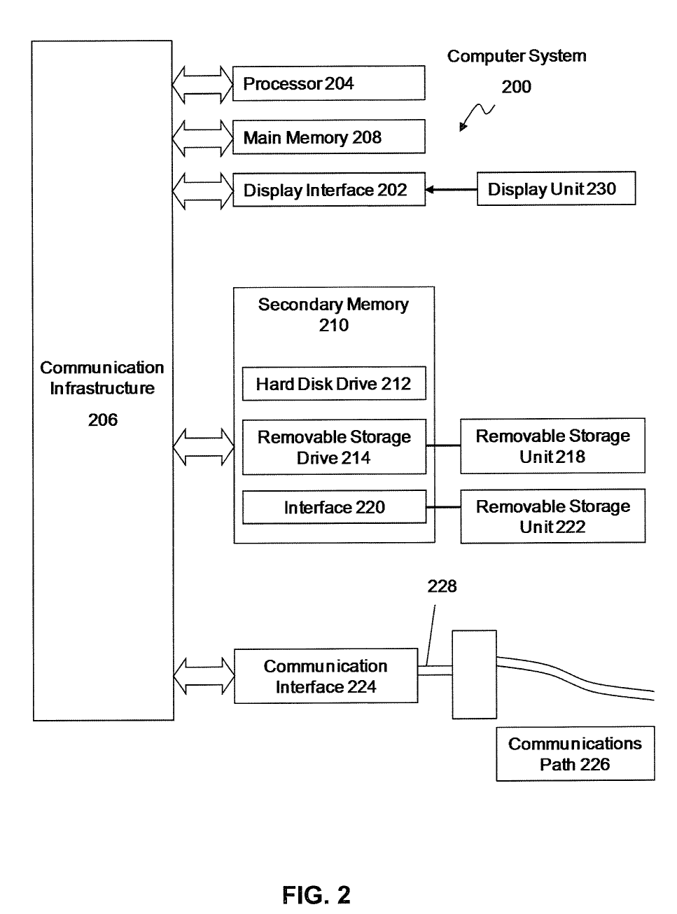

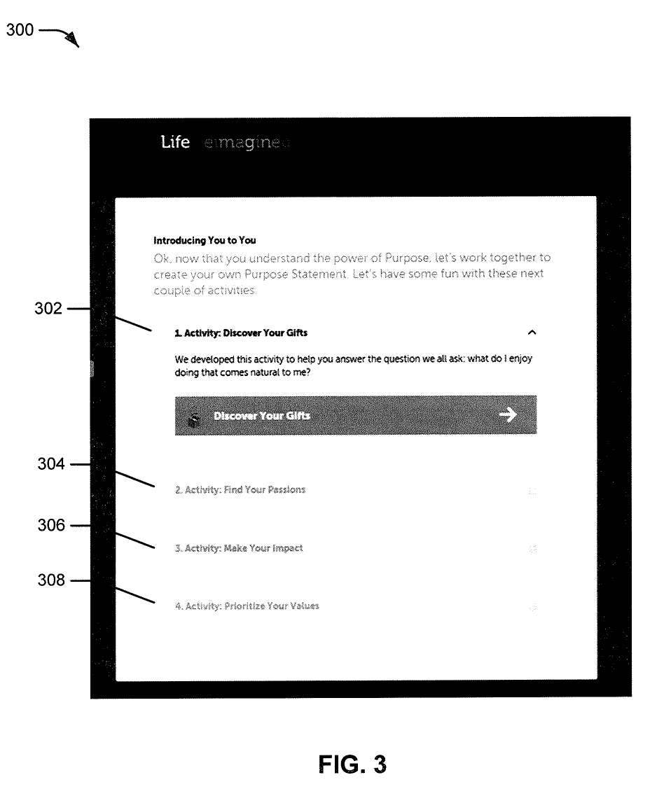

Aspects of the present disclosure may be implemented using hardware, software executed by a processor, or a combination thereof and may be implemented in one or more computer systems or other processing systems. For example, the user interfaces illustrated in FIGS. 3-13 may be implemented as a computer system or processing system. Also, the coaching system 50, guide system 60, and content system 80 (FIG. 1) may be implemented as a computer system or processing system. In an aspect of the present invention, features are directed toward one or more computer systems capable of carrying out the functionality described herein. An example of such a computer system 200 is shown in FIG. 2.

Computer system 200 includes one or more processors, such as processor 204. The processor 204 is coupled to a communication infrastructure 206 (e.g., a communications bus, cross-over bar, or network). Various software aspects are described in terms of this example computer system. After reading this description, it will become apparent to a person skilled in the relevant art(s) how to implement aspects hereof using other computer systems and/or architectures.

Computer system 200 may include a display interface 202 that forwards graphics, text, and other data from the communication infrastructure 206 (or from a frame buffer not shown) for display on a display unit 230. Computer system 200 may include a main memory 208, preferably random access memory (RAM), and may also include a secondary memory 210. The secondary memory 210 may include, for example, a hard disk drive 212 and/or a removable storage drive 214, e.g., an optical disk drive. The removable storage drive 214 may read from and/or write to a removable storage unit 218 in a well-known manner. As will be appreciated, the removable storage unit 218 may include a computer readable storage medium having stored therein computer software and/or data.

Alternative aspects of the present invention may include secondary memory 210 and may include other similar devices for allowing computer programs or other instructions to be loaded into computer system 200. Such devices may include, for example, a removable storage unit 222 and an interface 220. Examples of such may include a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 may allow software and data to be transferred among computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 may be in the form of signals 228, which may be electronic, electromagnetic, optical or other signals capable of being received by communications interface 224. These signals 228 may be provided to communications interface 224 via a communications path (e.g., channel) 226. This path 226 may carry signals 228 and may be implemented using wire or cable, fiber optics, a telephone line, a cellular link, a radio frequency (RF) link and/or other communications channels. As used herein, the terms “computer readable medium,” “computer program medium,” and “computer usable medium” refer generally to media such as a removable storage drive 280, and/or a hard disk installed in hard disk drive 270. These computer program products may provide software to the computer system 200. Aspects of the present invention are directed to such computer program products.

Computer programs (also referred to as computer control logic) may be stored in main memory 208 and/or secondary memory 210. Computer programs may also be received via communications interface 224. Such computer programs, when executed, may enable the computer system 200 to perform the features in accordance with aspects of the present invention, as discussed herein. In particular, the computer programs, when executed, may enable the processor 204 to perform the features in accordance with aspects of the present invention. Accordingly, such computer programs may represent controllers of the computer system 200.

Where aspects of the present invention may be implemented using software, the software may be stored in a computer program product and loaded into computer system 200 using removable storage drive 214, hard disk drive 212, or interface 220. The control logic (software), when executed by the processor 204, may cause the processor 204 to perform the functions described herein. In another aspect of the present disclosure, the system may be implemented primarily in hardware using, for example, hardware components, such as application specific integrated circuits (ASICs). Implementation of the hardware state machine so as to perform the functions described herein will be apparent to persons skilled in the relevant art(s). In yet another variation, aspects of the present disclosure may be implemented using a combination of both hardware and software.

FIG. 3 illustrates an example interface 300 for organizing activities for discovering a purpose. The interface 300 may guide a user 30 through activities to discover personal traits in different categories. Example categories include gifts 302, passions 304, impacts 306, and values 308. Gifts may be qualities or abilities that the user 30 currently has. Passions may be activities that the user 30 enjoys. Impacts may be people, groups, or things that the user 30 wants to have an effect upon. Values may be characteristics or beliefs that the user 30 believes are important. A different activity may be provided for each category. The interface 300 may guide the user 30 through each of the activities until personal traits are selected in each category. The interface 300 may also allow the user 30 to navigate to a previous activity to view results or repeat the activity.

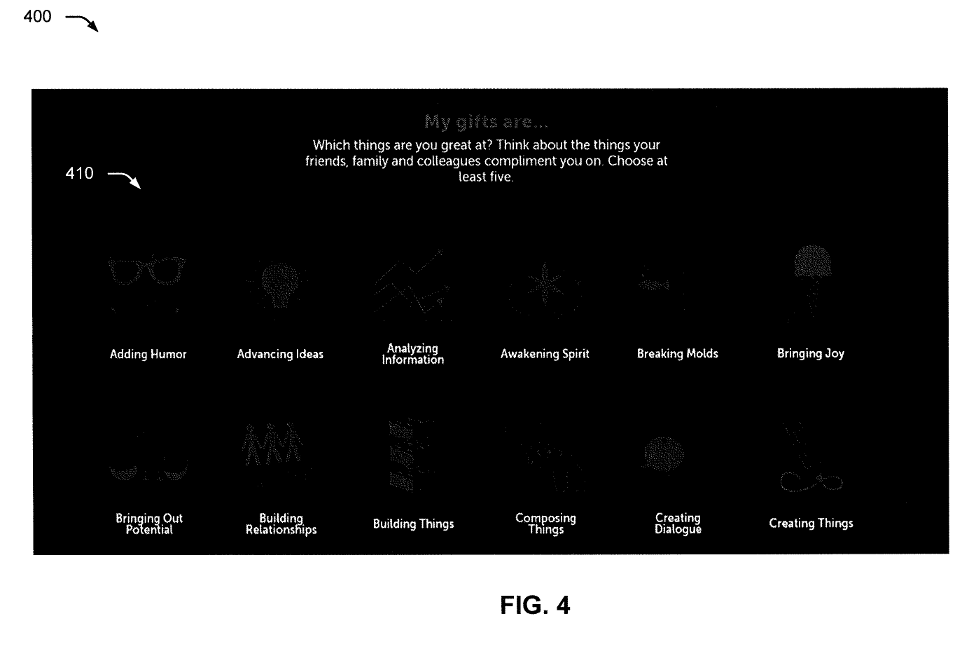

FIG. 4 illustrates an example interface 400 for selecting personal traits. The interface 400 may present a plurality of cards 410. Each of the cards 410 may include a textual description of a personal trait and/or an image representing the personal trait. Each of the cards may be further associated with a category of personal trait. In an aspect, each of the cards 410 may be displayed as a selectable icon. In an aspect, the interface 400 may present the cards 410 in a random order. The random order may prevent biasing the user towards particular personal traits. In an aspect, the interface 400 may reshuffle the cards to present them in a different order. The cards 410 may be selectable by a user 30 (e.g., using a mouse or touch screen). When selected, a card 410 may indicate selection, for example, by changing color(s), adding a border, or changing size. The interface 400 may allow selection of at least a minimum number (e.g., 5) of cards 410.

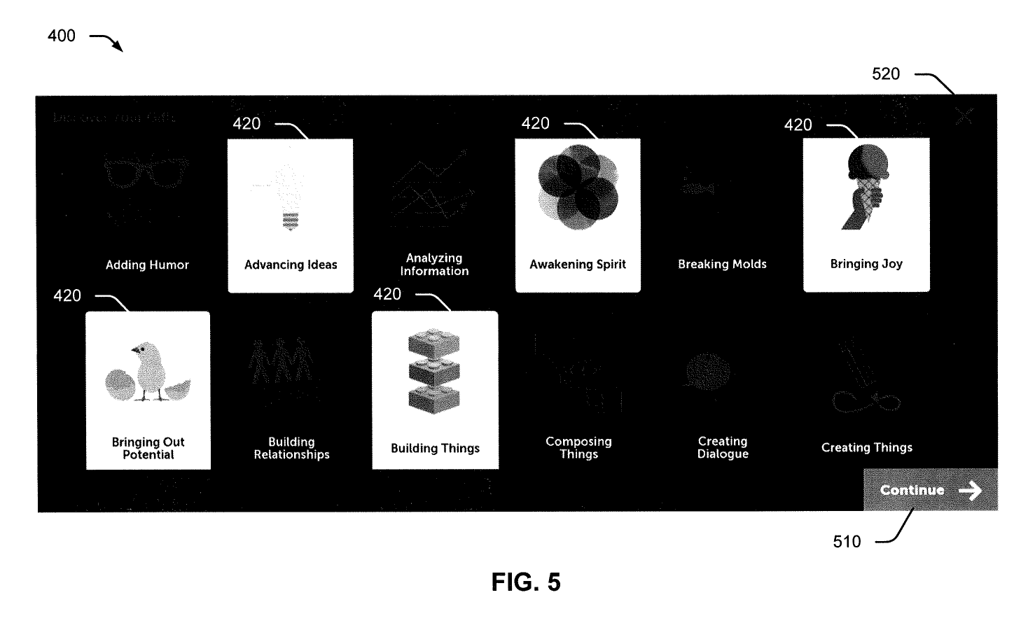

FIG. 5 illustrates the example interface 400 having several cards 410 selected. For example, the selected cards may be displayed with a different background color and a polychromatic image whereas the unselected cards are displayed with a monochromatic image. The different display of the selected and unselected cards may convey that the selected cards are more important and prompt the user to evaluate the importance of the other cards. When the minimum number has been selected, the interface 400 may display a navigation button 510 (e.g., an arrow) to advance the activity. The user 30, however, may select additional cards after selecting the minimum number of cards. Accordingly, the user 30 may select as many personal traits within the category as are applicable to the user 30. The interface 400 may also include a navigation button 520 to cancel the activity.

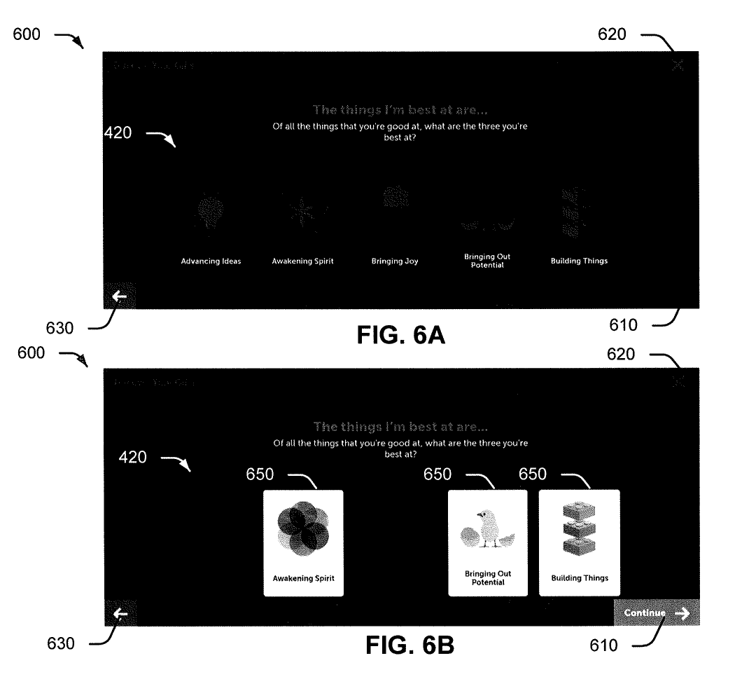

FIGS. 6A and 6B illustrate an interface 600 for narrowing a first selected subset of personal traits to obtain a second subset of selected traits. The interface 600 may display the first subset of cards 410 selected from the interface 400. The interface 600 may not display any cards 410 that were not selected in the interface 400. The interface 600 may allow selection of a maximum number of cards (e.g., 3). As with interface 400, selecting a card may change the color of the selected card or otherwise indicate selection. FIG. 6B illustrates the interface 600 with three cards selected. The navigation button 610 may activate and become selectable when the maximum number of cards has been selected. The interface 600 may also include a navigation button 630 to return to the interface 400.

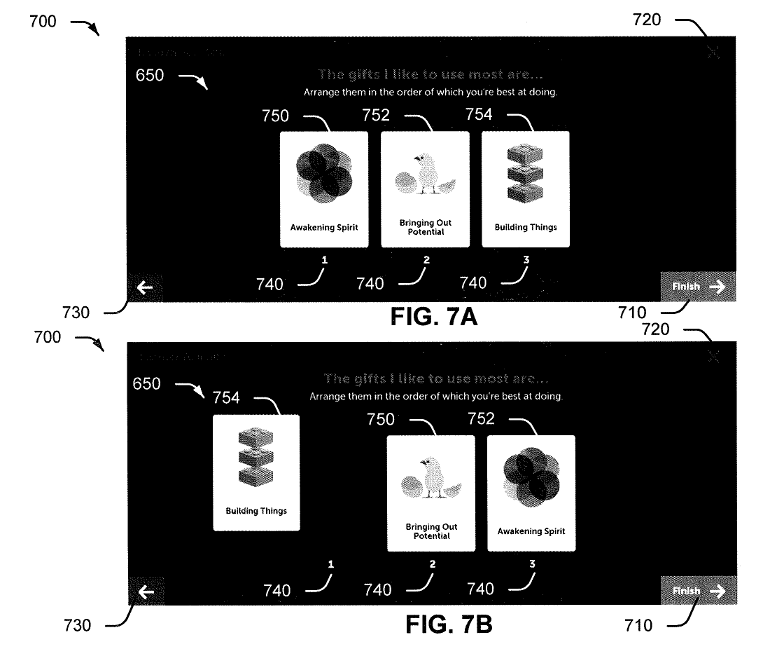

FIGS. 7A and 7B illustrate an example interface 700 for ordering the second selected subset of personal traits. The interface 700 may display each of the maximum number of selected cards. For example, the second selected subset may include cards 750, 752, and 754. The selected cards 410 may be displayed in the same manner as the selected cards 410 in interface 400 or interface 600. The interface 700 may also indicate ordinal positions 740 for the cards. For example, the ordinal positions may be indicated by number, letters, a color scale, or another indication of importance. As illustrated in FIG. 7A, the interface 700 may initially have card 750 in a first position, card 752 in a second position, and card 754 in a third position. The interface 700 may allow a user 30 to change the order of the cards 410. For example, as illustrated in FIG. 7B, a user 30 may select the card 754 (e.g., by clicking) in the third position and moving the card 754 (e.g., by dragging) the card 754 to a different position, for example, the first position. When the card 754 is released in the new position, the other cards 750, 752 may automatically reposition themselves based on the new position. The interface 700 may also include a navigation button 710 to finish the activity for the category. The navigation button 710 may return the user 30 to the interface 300 for selecting a different activity for a different category. The interface 700 may also include a navigation button 720 to cancel the activity and a navigation button 730 to return to the interface 600.

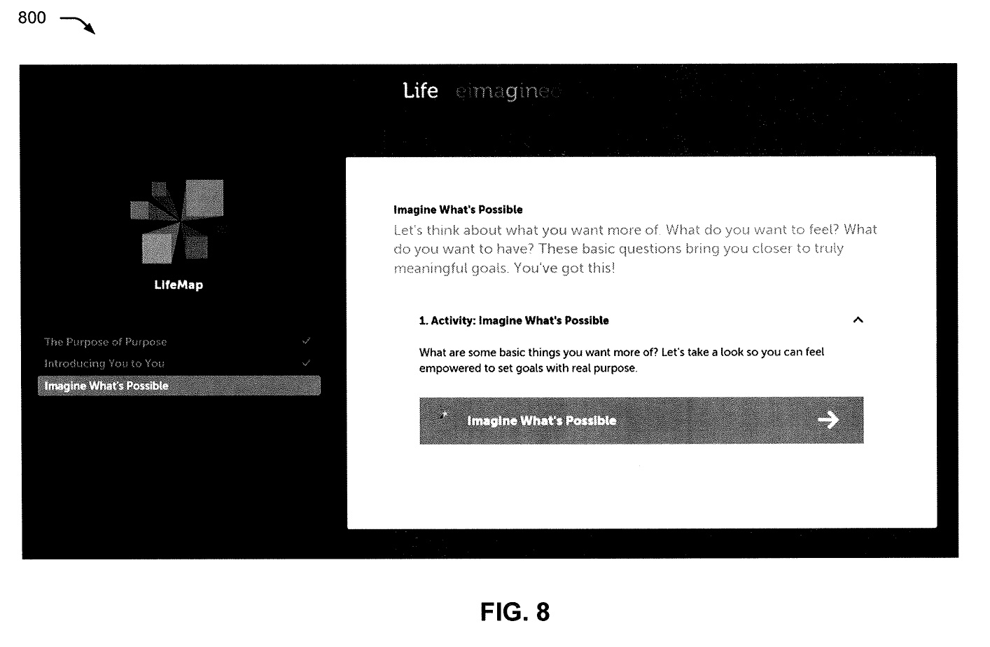

In an aspect, each of the categories 302, 304, 306, 308 may use interfaces 400, 600, and 700 to select personal traits and obtain a second subset including a maximum number of personal traits. The system 100 may also provide for a user 30 to select possibilities. A possibility may be a desired feeling for the user 30. FIG. 8 illustrates an interface 800 for organizing an activity for selecting possibilities. In an aspect, the interface 800 may be similar to the interface 300. In an aspect, the activity for selecting possibilities may be included in the interface 300 instead of the interface 800. In an aspect, the possibilities may be selected using interfaces 400, 600, 700.

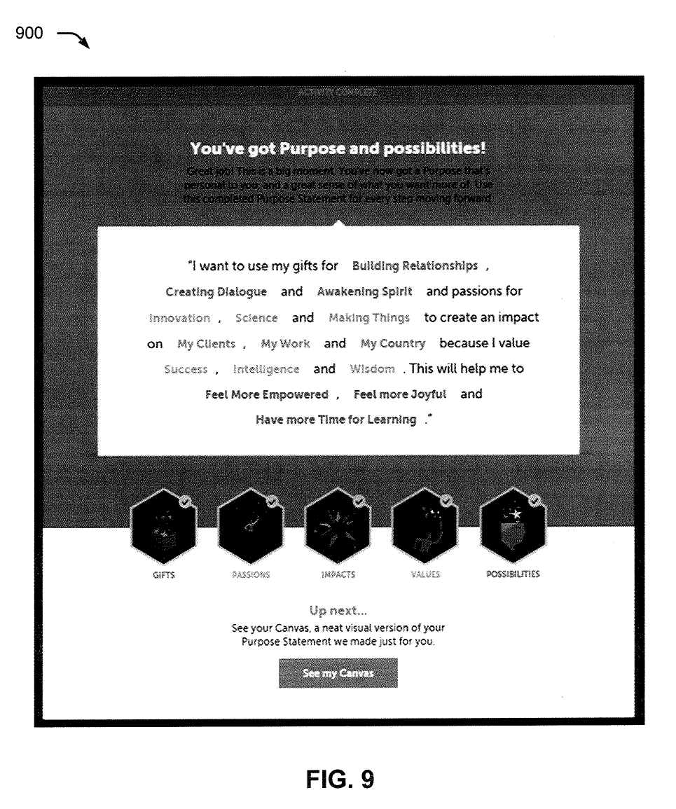

FIG. 9 illustrates an example interface 900 for displaying a personal purpose statement. The system 100 may build the personal purpose statement based on the personal traits and possibilities selected by the user 30. The user 30 may be presented with a partially completed interface 900 post completion of each activity from interfaces 400, 600, 700.

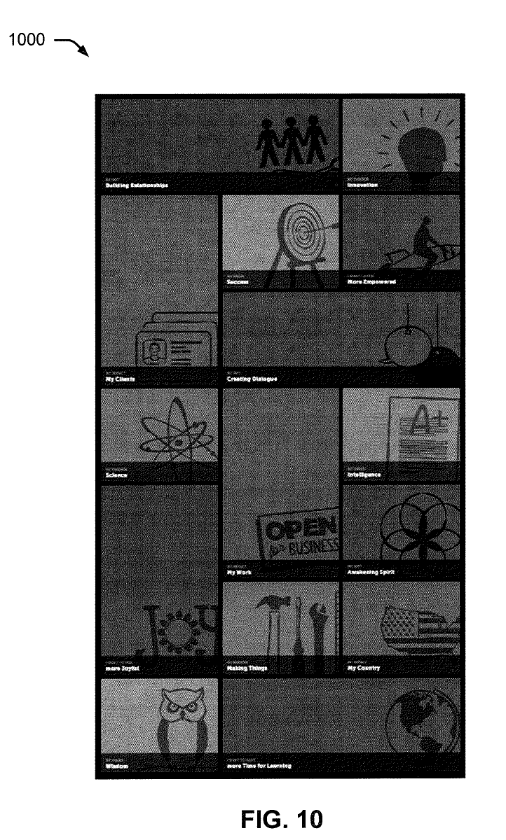

FIG. 10 illustrates an example interface 1000 for displaying a personal canvas. The canvas may be an example of a map showing the traits of a user. The canvas may include a plurality of rectangles. Each rectangle may include one of the selected personal traits and an image associated with the personal trait. In an aspect, the rectangles may be customizable with a personal purpose statement and personal images. For example, when a rectangle is selected, the interface 1000 may prompt the user 30 to enter thoughts related to the corresponding personal trait. The interface 1000 may ask a question based on the personal trait and the personal purpose statement. The interface 1000 may provide for selection of a personal image by accessing an image database of the user 30 on the user device 20 and/or within the network 40 (e.g., on a cloud storage device, network service, or social media platform). The user 30 may select an image to associate with the personal trait. The image may then be displayed in the rectangle. In an aspect, the personal canvas may allow the user 30 to visualize his or her personal traits. The personal canvas may provide inspiration for creating goals. The personal purpose statement may be layered on top of the personal canvas.

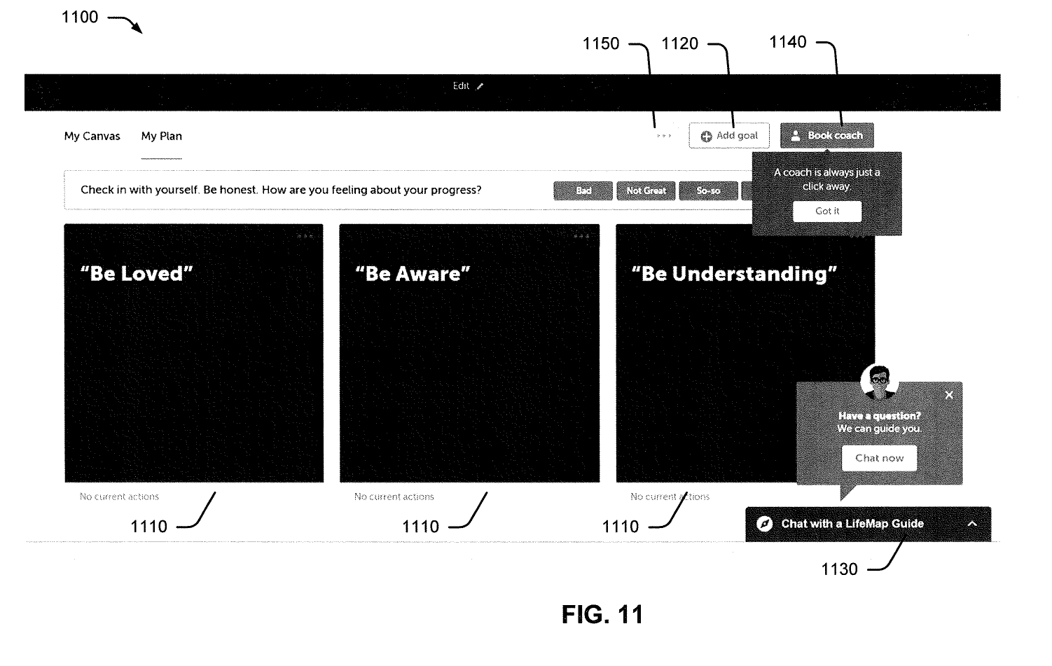

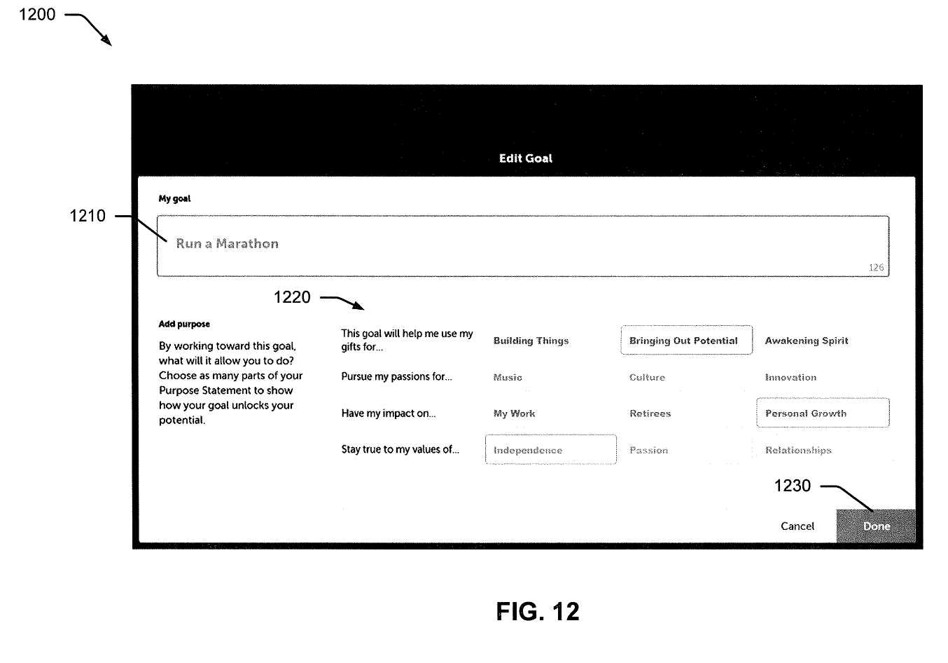

FIG. 11 illustrates an interface 1100 for managing an action plan including goals 1110. In an aspect, the system 100 may populate the interface 1100 with goals based on the possibilities selected by the user 30. The user 30 may also add additional goals to the action plan by selected the add goal button 1120, which may initiate an interface 1200, discussed below with respect to FIG. 12. The interface 1100 may also provide a chat button 1130, which may provide for communication with a guide 65 via the guide system 60 (FIG. 1). A guide 65 may be a customer service specialist who can help navigate the system 100. The guide may provide instructions or other assistance to the user 30. In an aspect, the chat button 1130 may open a chat interface for entering and receiving text messages. The chat button 1130 may also allow for a voice connection with the guide 65. Communications systems known in the art (e.g., chat applications, voice over Internet protocol (VoIP), or other methods) may be used to establish the selected communication with the guide.

The interface 1100 may also include a coach button 1140. The coach button 1140 may allow a user to schedule an appointment with a coach 55 (FIG. 1). A coach may differ from a guide in that the coach may provide specialized guidance toward a goal in the form of a video call. The coach 55 may be a certified individual. The coach button 1140 may initiate a scheduling service provided by the coaching system 50 (FIG. 1) that allows the user 30 to select a coach 55 and see availability for the selected coach 55. In an aspect, the system 100 may recommend a coach 55 based on a certification matching a goal or personal trait of the user 30. The user 30 may schedule a specific time with the coach 55. At the selected time, the system 100 may provide a video call between the user 30 and the coach 55. For example, the system 100 may initiate a video call between a user device 20 and the coach 55, who may access the system 100 using a coach device, which may be similar to the user device 20. In an aspect, the system 100 may also account for use of coaching. In an aspect, the user 30 may subscribe to a service and receive an allocation of coaching minutes, which may be used to obtain coaching sessions. In another aspect, a user 30 may purchase coaching minutes separately from a subscription. The system 100 may determine a duration of a coaching session based on a scheduled duration or an actual duration. The system 100 may then subtract the duration of the coaching session from the allocation of coaching minutes.

FIG. 12 illustrates an interface 1200 for setting a new goal or editing a goal. The interface 1200 may include a goal field 1210 that may allow a user to enter a goal. The interface 1200 may also include selectable traits 1220. The selectable traits 1220 may be based on the personal traits selected by the user 30. In the interface 1200, the user 30 may choose selectable traits 1220 that relate to the goal. The interface 1200 may also include navigation button 1230 for finalizing the goal.

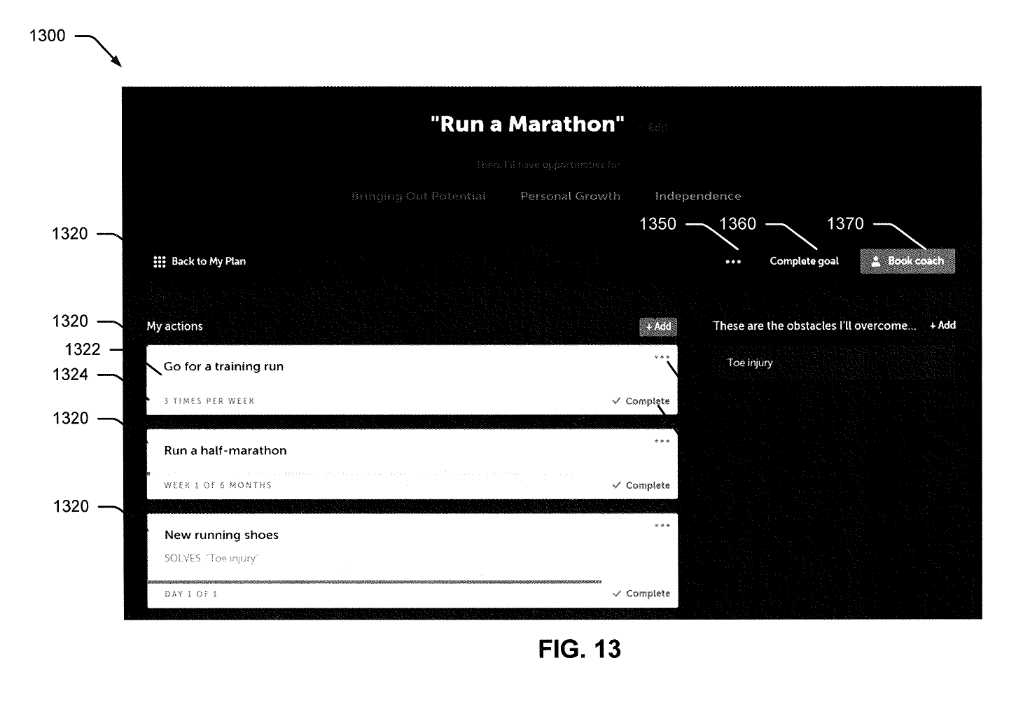

FIG. 13 illustrates an interface 1300 for managing a goal. The interface 1300 may include an add action button 1310. The add action button may allow a user 30 to add an action such as actions 1320. Each action 1320 may include an action description field 1322, a time commitment 1324, a pause button 1326, and a complete button 1328. The action description field 1322 may include text entered by the user 30. The time commitment 1324 may include a frequency for performing the action or a time period for completing the action. In an aspect, the time commitment may be adjusted using a slider (not shown). The pause button 1326 may be used to pause the action. Paused actions may be listed separately and the time commitment 1324 may be inapplicable. The complete button 1328 may be used to indicate that an action has been completed. The interface 1300 may also include obstacles 1340. The interface 1300 may allow the user to enter an obstacle that prevents progress toward the goal or completion of an action. The interface 1300 may also prompt the user to identify an action that will solve or overcome the obstacle. The interface may add a new action for overcoming the obstacle. Accordingly, the interface 1300 may help the user 30 identify and overcome obstacles while working toward a goal. The interface 1300 may also include a pause goal button 1350 for pausing a goal and a complete goal button 1360 for indicating that the goal has been completed. The interface 1300 may also include a book coach button 1370, which may be similar to the coach button 1140, discussed above.

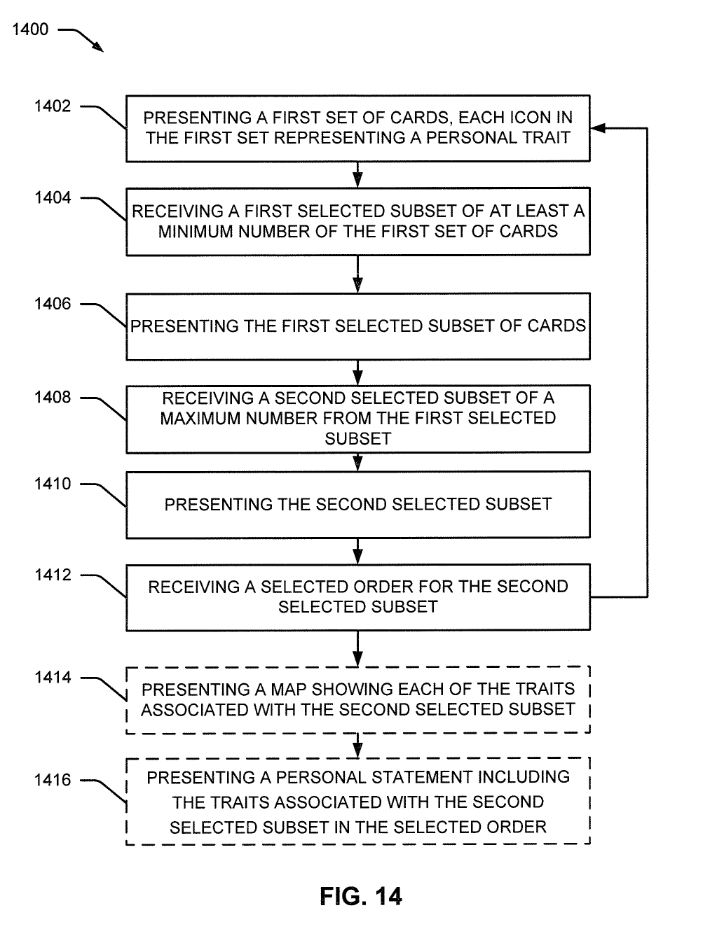

Referring to FIG. 14, in an operational aspect, a computer system 200 (FIG. 2) such as the user device 20 (FIG. 1) or a server 42 (FIG. 1) may perform one aspect of a method 1400 for encouraging personal discovery. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In block 1402, the method 1400 may include presenting a first set of cards, each card in the first set representing a personal trait. For example, the user device 20 may present the interface 400 including a first set of cards, each card in the first set representing a personal trait. In an aspect, the cards may be an example of icons that may be used to represent the personal traits. In block 1402, the method 1400 may include receiving a first selected subset 420 of at least a minimum number of the first set of cards. For example, the user device 20 may receive the first selected subset 420 of at least a minimum number of the first set of cards 410. In an aspect, the user 30 may select the first selected subset 420 using the interface 400. In block 1406, the method 1400 may include presenting the first selected subset of cards. For example, the user device 20 may present the interface 600 including the first selected subset 420 of cards 410. In an aspect, presenting the first selected subset of cards may include presenting the selected subset of cards separately from any unselected cards. In block 1408, the method 1400 may include receiving a second selected subset 650 of a maximum number from the first selected subset 420. For example, the user device 20 may receive a second selected subset 650 of a maximum number from the first selected subset 420. In an aspect, the user 30 may select the second selected subset 650 using the interface 600. In block 1410, the method 1400 may include presenting the second selected subset. For example, the user device 20 may present the interface 700 including the second selected subset 650. In an aspect, presenting the second selected subset of cards may include presenting the second selected subset of cards separately from any unselected cards. Further, the second selected subset of cards may be presented in initial ordinal positions. In block 1412, the method 1400 may include receiving a selected order for the second selected subset. For example, the user device 20 may receive the selected order for the second selected subset 650. In an aspect, the user 30 may select the order for the second selected subset 650 using the interface 700. Further, following block 1412, the method 1400 may return to block 1402 for selecting personal traits in a different category. For example, the user device 20 may return to block 1402 for selection of personal traits in each of the categories of: gifts, passions, impacts, values, and feelings, or any combination thereof. In block 1414, the method 1400 may optionally include presenting a map showing each of the traits associated with the second selected subset for each category. For example, the user device 20 may display the interface 1000 including the canvas or a different map. In block 1416, the method 1400 may include presenting a personal purpose statement including the traits associated with the second selected subset in the selected order. For example, the user device 20 may present the interface 900 including a personal purpose statement.

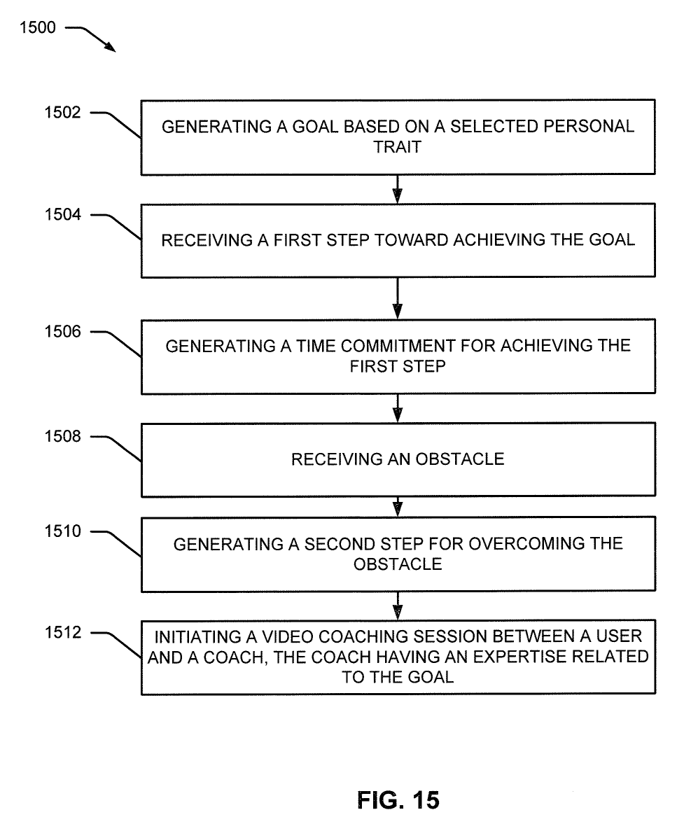

Referring to FIG. 15, in an operational aspect, a computer system 200 (FIG. 2) such as the user device 20 (FIG. 1) or a server 42 (FIG. 1) may perform one aspect of a method 1500 for setting and achieving goals. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In block 1502, the method 1500 may include generating a goal based on a selected personal trait. For example, the server 42 may generate a goal 1110 on interface 1100 based on a selected personal trait. In block 1504, the method 1500 may receive a first step toward achieving the goal. For example, the server 42 may receive a first step from the user device 20 toward achieving the goal. The first step may be an action 1320 on interface 1300. In block 1506, the method 1500 may include generating a time commitment for achieving the first step. For example, the server 42 or user 30 may generate the time commitment for achieving the first step. In block 1508, the method 1500 may include receiving an obstacle. For example, the server 42 may receive an obstacle 1340 from the user device 20. In block 1510, the method 1500 may include generating a second step for overcoming the obstacle. For example, the server 42 may generate the second step for overcoming the obstacle 1340. In block 1512, the method 1500 may include initiating a video coaching session between a user and a coach, the coach having an expertise related to the goal. For example, the server 42 may initiate a video coaching session between a user 30 at user device 20 and a coach 55 at coaching system 50. The block 1512 may be performed at any time during the method 1500.

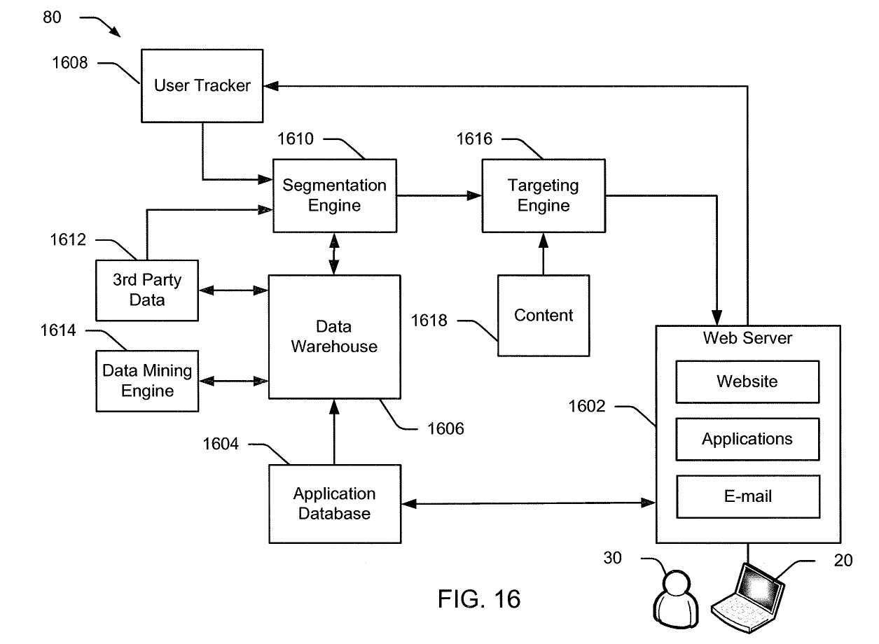

FIG. 16 illustrates a block diagram showing an example architecture of the content system 80 (FIG. 1). The content system 80 may serve content 1618 to a user 30 via the user device 20. For example, the content system 80 may include a web server 1602 for presenting a web site, providing applications, and/or sending email. The web server 1602 may serve content 1618 to the user 30 by, for example, sending emails, messages, tweets, or other direct communications, populating content within one or more applications, and/or providing a website displaying content. In an aspect, the content system 80 may customize the website for a particular user 30. For example, the content system 80 may determine which activities to recommend to the user 30 on the website. The content system 80 may also recommend editorial content (e.g., articles, videos, presentations, links, etc.) for the user 30. In an aspect, the web server 1602 may also customize any of the interfaces described herein for display on a particular user device 20. For example, the web server 1602 may include a rendering engine for providing a display on the user device 20 based on templates for the type of device. The web server 1602 may provide user information to various components of the content system 80.

The application database 1604 may receive and store user information based on interactions the user 30 has with a web application provided by the web server 1602. For example, each of the interfaces described herein may be included in the web application. The user input into the interfaces (e.g., selected cards, order, goals, time commitments, and obstacles) may be stored in the application database 1604. The application database 1604 may also store the personal purpose statement and the personal canvas. The application database 1604 may further store any free text entries the user 30 enters into any of the interfaces. The application database 1604 may further interact with the web server 1602 to provide the web application. For example, the web server 1602 may control user registration and security for controlling access to information stored in application database 1604.

The content system 80 may also collect user data via a user tracker 1608. The user tracker 1608 may include any user tracking software or service known in the art for monitoring user interactions with a website. The user tracker 1608 may, for example, collect information regarding pages visited, time spent on each page, mouse clicks, and scrolling information. The user tracker 1608 may build user profiles. The segmentation engine 1610 may match user profiles created by the user tracker 1608 with user profiles created via the web application and stored in application database 1604. In an aspect, the segmentation engine may classify users into archetype groups based on the combination of personal traits selected by the users 30.

The data warehouse 1606 may be a structured database for storing aggregated user information from the application database 1604 and the user tracker 1608. For example, the data warehouse 1606 may be a structured query language (SQL) database. The data warehouse 1606 may also acquire user data from third parties, which may be overlaid and/or correlated with user profiles. A data mining engine 1614 may access the data warehouse 1606 for researching user qualities.

The segmentation engine 1610 may further generate user segments for content distribution. The user segments may be groups of users that the content system 80 provides similar content. In an aspect, the segmentation engine 1610 may generate a segment of one for each user 30. For example, the segmentation engine 1610 may generate a unique profile of user characteristics that may be used to select content for the user.

The targeting engine 1616 may determine when and how to display particular content to the user 30. In an aspect, the targeting engine 1616 may use business rules to match content to one or more user segments. For example, the targeting engine 1616 may apply the business rules to application events, triggers, and program taxonomy to determine which content to distribute. The business rules may also determine how to distribute the content (e.g., display on website versus email).

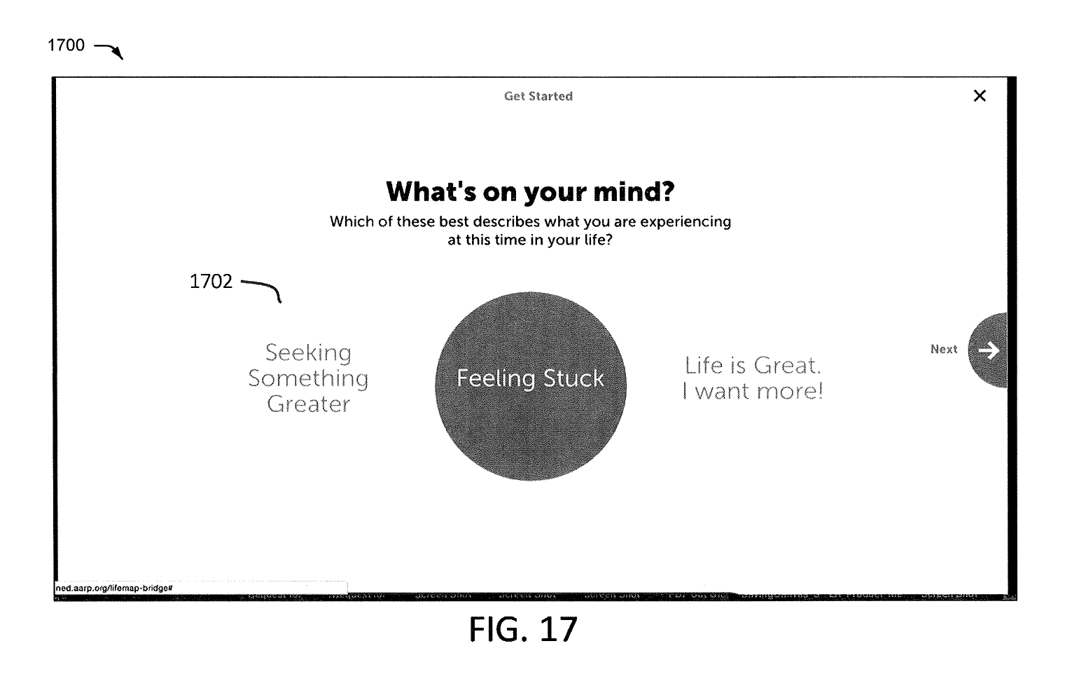

FIG. 17 illustrates an interface 1700 for displaying user mind states. The user 30 may select their current mind state from presented mind states. When viewing mind states a selected a mind state 1702 may indicate selection for example displaying additional descriptive text, changing colors, adding a border, or changing the size.

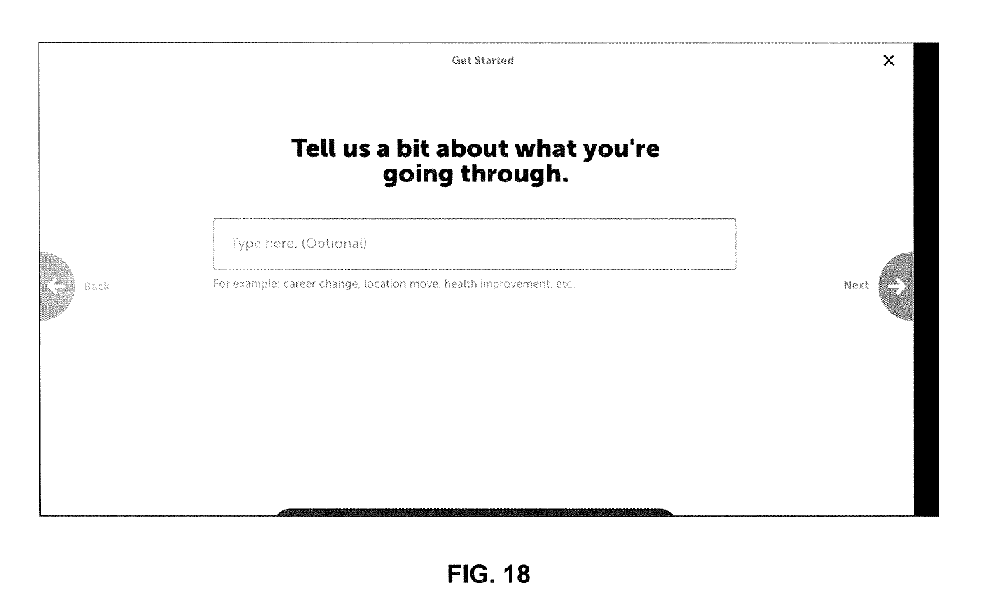

FIG. 18 illustrates an interface for allowing the user 30 to describe their life situation related to select current state of mind from FIG. 17.

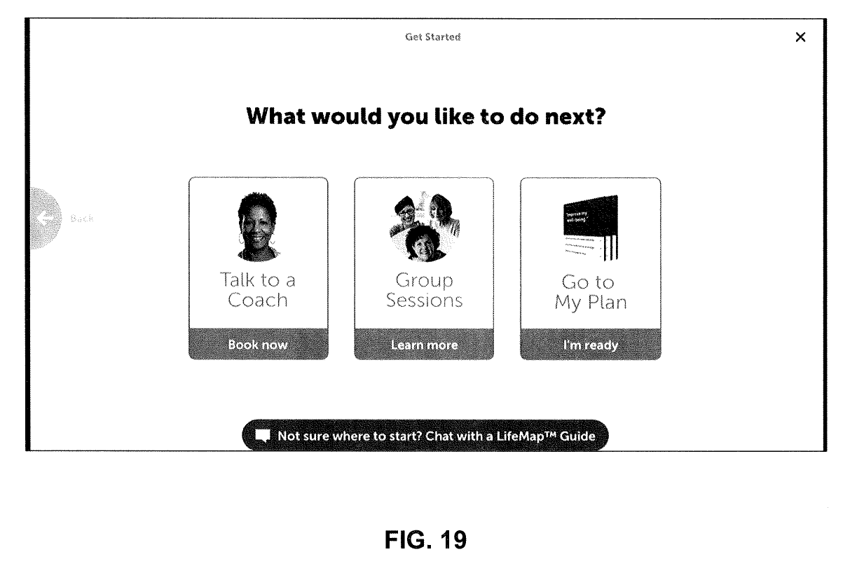

FIG. 19 illustrates an interface for allowing the user 30 to select which part of system 100 to navigate to next.

As used in this application, the terms “component,” “module,” “system” and the like are intended to include a computer-related entity, such as but not limited to hardware, firmware, a combination of hardware and software, software stored as executable instructions on a non-transitory computer readable medium, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. While the foregoing disclosure discusses illustrative aspects and/or embodiments, it should be noted that various changes and modifications could be made herein without departing from the scope of the described aspects and/or embodiments as defined by the appended claims. Additionally, all or a portion of any aspect and/or embodiment may be utilized with all or a portion of any other aspect and/or embodiment, unless stated otherwise.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A method for providing a guide to development, comprising:
presenting, to a user at a user device, a first set of cards, each card in the first set of cards representing a personal trait, the personal traits being generated by a server and being transmitted to the user device via a network;
receiving, via the network, a first selected subset of at least a minimum number of the first set of cards, the minimum number being at least three;
presenting, to the user at the user device, the first selected subset;
receiving, via the network, a second selected subset of a maximum number from the first selected subset, the maximum number being less than the minimum number;
presenting, to the user at the user device, the second selected subset;
receiving, via the network, an order selected by the user for the second selected subset; and
generating, by the server, a personal purpose statement for the user including the personal traits associated with the second selected subset in the selected order.

2. The method of claim 1, further comprising:
generating, by the server, a map showing each of the personal traits associated with the second selected subset.

3. The method of claim 1, wherein the personal traits are grouped into categories of personal traits, the categories including at least one of: gifts, passions, impacts, values, or feelings.

4. The method of claim 1, further comprising receiving an additional second selected subset and an order for the second selected subset for each category of personal traits.

5. The method of claim 1, further comprising:
generating, by the server, a goal based on a selected personal trait;
receiving, from the user device via the network, a first step toward achieving the goal; and
generating a time commitment for achieving the first step.

6. The method of claim 5, further comprising:
receiving, from the user device via the network, an obstacle; and
generating, by the server, a second step for overcoming the obstacle.

7. The method of claim 5, further comprising initiating a video coaching session between the user and a coach via the network, the coach having an expertise related to the goal.

8. The method of claim 7, further comprising:
determining, by the server, a balance of coaching time of the user;
determining, by the server, a duration of the video coaching session; and
deducting, by the server, the duration of the video coaching session from the balance of coaching time.

9. The method of claim 1, further comprising:
generating a user profile including the selected personal traits; and
selecting content to provide to the user based on the selected personal traits.

10. A computer system for providing a guide to development, comprising:
a server communicatively coupled to a user device via a network;
a first graphical user interface (GUI), generated by the server and transmitted to the user device, including a first set of cards, each card in the first set of cards representing a personal trait, wherein each card is toggle-able between a selected state and an unselected state, and a navigation button for advancing from the first GUI, wherein the navigation button is activated only when a minimum number of cards is in the selected state;
a second dynamically generated GUI including a first selected subset of the first set of cards, wherein each card is toggle-able between the selected state and the unselected state and the second GUI permits only a maximum number of the first selected subset of the first set of cards to be in the selected state, and a navigation button for advancing from the second GUI;
a third dynamically generated GUI including a second selected subset of the first selected subset of the first set of cards, arranged in ordinal positions, wherein the GUI permits movement of a selected card to a different ordinal position and automatically changes the ordinal positions of any unselected cards.

11. The computer system of claim 10, further comprising:
a fourth GUI presenting a map showing each of the personal traits associated with the second selected subset, the fourth GUI allowing customization of the map when each of the personal traits is selected.

12. The computer system of claim 11, further comprising:
a fifth GUI presenting a personal purpose statement including the personal traits associated with the second selected subset in the order of the ordinal positions.

13. The computer system of claim 10, wherein the personal traits are grouped into categories of personal traits, the categories including at least one of: gifts, passions, impacts, values, or feelings.

14. The computer system of claim 13, wherein the first GUI, second GUI, and third GUI are dynamically generated for each of the at least one category of personal traits.

15. The computer system of claim 10, further comprising:
a sixth GUI configured to display a goal based on at least one selected personal trait, at least one step toward meeting the goal, and an obstacle preventing meeting the goal, wherein the at least one step includes a step that overcomes the obstacle.

16. A non-transitory computer readable medium storing computer executable instructions for providing a guide to development, comprising instructions to:
present, to a user at a user device, a first set of cards, each card in the first set of cards representing a personal trait, the personal traits being generated by a server and being transmitted to the user device via a network;
receive, via the network, a first selected subset of at least a minimum number of the first set of cards, the minimum number being at least three;
present, to the user at the user device, the first selected subset;
receive, via the network, a second selected subset of a maximum number from the first selected subset, the maximum number being less than the minimum number;
present, to the user at the user device, the second selected subset;
receive, via the network, an order selected by the user for the second selected subset; and
generate, by the server, a personal purpose statement for the user including the personal traits associated with the second selected subset in the selected order.

17. The non-transitory computer readable medium of claim 16, further comprising instructions to generate, by the server, a map showing each of the personal traits associated with the second selected subset.

18. The non-transitory computer readable medium of claim 16, wherein the personal traits are grouped into categories of personal traits, the categories including at least one of: gifts, passions, impacts, values, or feelings.

19. The non-transitory computer readable medium of claim 16, further comprising instructions to receive an additional second selected subset and an order for the second selected subset for each category of personal traits.

20. The non-transitory computer readable medium of claim 16, further comprising instructions to:
generate, by the server, a goal based on a selected personal trait;
receive, from the user device via the network, a first step toward achieving the goal; and
generate a time commitment for achieving the first step.
